(19) United States
(12) Patent Application Publication
(10) Pub. No.: US 2006/0181863 A1
(43) Pub. Date: Aug. 17, 2006

(54) Light emitting diode display having light guide plate

(75) Inventors: Tseng Fu-Yen, Taipei City (TW); Wu Chao-Ming, Yi Lan City (TW); Chien Ching-Tsung, Mei Feng Village (TW)

Correspondence Address: CHARLES E. BAXLEY, ESQ., 90 JOHN STREET, THIRD FLOOR, NEW YORK, NY, 10038, US

(73) Assignee: Lite-On Technology Corp.

(21) Appl. No.: 11/405,054

(22) Filed: Apr. 17, 2006

Related U.S. Application Data
(63) Continuation-in-part of application No. 10/759,370, filed on Jan. 15, 2004.

(51) Int. Cl. G01D 11/28

(52) U.S. Cl. 362/27; 362/612

(57) ABSTRACT

A light emitting diode display having light guide plate comprises a light emitting diode display, a light guide plate and at least a light source. The light guide plate is disposed in the front of the display panel of the display and the light is projected by the light source and enters to the light guide plate. The light can reflect in the light guide plate. When the light passes through the light guide plate, the light guide plate is colorful because of the color of the light from the light source or a mixture of the color of the light and the color of the display panel.

This application is a continuation of part of U.S. patent application Ser. No. 10/759,370 filed on Jan. 18, 2006, which claims the benefit of the earlier filing date.

### BACKGROUND OF THE INVENTION

1. Field of the Invention

The present invention relates to light emitting diode display that is applied to household appliances, computer equipments, electronic instruments, communication apparatuses, and the likes, and more particularly to the light emitting diode display wherein the display screen can form a light screen effect.

2. Description of the Prior Arts

Nowadays, displays for displaying characters and graphics generally includes vacuum fluorescent display (VFD), electro-luminescent (EL), light emitting diode (LED) and light crystal display (LCD), which are often applied to all kinds of products, such as acoustic equipments, household appliances, computer, communication apparatuses or display control panel for electronic instruments.

The VFD, EL and the LED can display characters or graphics directly, whereas the LCD should be incorporated with back light source with even brightness. Taiwanese Patent Publication No. 200302375 discloses a LCD with back light assembly, wherein the back light assembly comprises a light assembly and a light guide plate. And it is noted that the back light assembly is set at the rear of display screen assembly of the LCD (far away from the user). By such arrangements, the light projected into the light guide plate by the light assembly can reflect and passes through the light guide plate, and thus enables the light guide plate to form surface light source, and then the light of the light guide plate can be evenly projected on the LCD, whereby to improve the brightness of the LCD.

No matter what type of display, the design of which only emphasizes on function for displaying the graphics or characters, or the brightness. To solve the brightness problem, the above-mentioned LCD of Taiwanese Patent Publication No. 200302375 provides a special configuration which is aimed at the light guide plate of the back light assembly. However, as far as the visual perception is concerned, none of the conventional displays is designed and structured by taking it into consideration.

U.S. Pat. No. 6,592,233 discloses a display that is non-emissive, and the disadvantage of this display is that the lighting effect is poor since it can't generate light source by itself and must require a light source to provide light source.

The present invention has arisen to mitigate and/or obviate the afore-described disadvantages of the conventional light emitting diode display.

### SUMMARY OF THE INVENTION

The primary object of the present invention is to provide a light emitting diode display having light guide plate, wherein a light guide plate is set in front of a display panel of the light emitting diode display, and plural different colored light sources are used to project light into the light guide plate, so as to form colorful light screen in the direction of user's sight.

The secondary object of the present invention is to provide a light emitting diode display having light guide plate, wherein a light guide plate is set in front of a display panel of the light emitting diode display, and plural different colored light sources are used to project light into the light guide plate at different turns, so as to bring about dynamic changes in color.

The third object of the present invention is to provide a light emitting diode display having light guide plate, wherein a light guide plate is set in front of a display panel of the light emitting diode display, and plural colored light sources are used to project light into the light guide plate, such that the color of the light projected by the light source can be mixed with the color of the display panel, so as to improve the color display effect.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a partial outside view of a household appliance equipped with a light emitting diode display in accordance with the present invention;

FIG. 2 is an assembly view of a light emitting diode display in accordance with the present invention;

FIG. 3 is a structural view of a light emitting diode display with SMD Lamp in accordance with the present invention;

FIG. 4 is an illustrative graphic of showing traveling path of the light projected by light source of a light emitting diode display in accordance with the present invention;

FIG. 5 is a structural view of a light emitting diode display in accordance with another embodiment of the present invention.

### DETAILED DESCRIPTION OF THE PREFERRED EMBODIMENTS

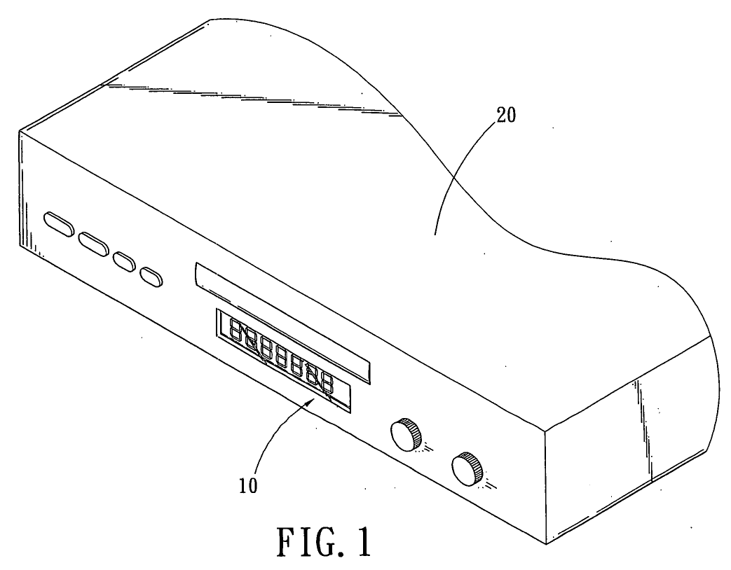

Referring to FIG. 1, a light emitting diode display 10 in accordance with the present invention is normally applied to household appliances 20, and it is capable of displaying characters and graphics. Besides the product shown in FIG. 1, the light emitting diode display 10 of the present invention 10 is also applied to computer equipments, electronic instruments, communication apparatuses, and the likes.

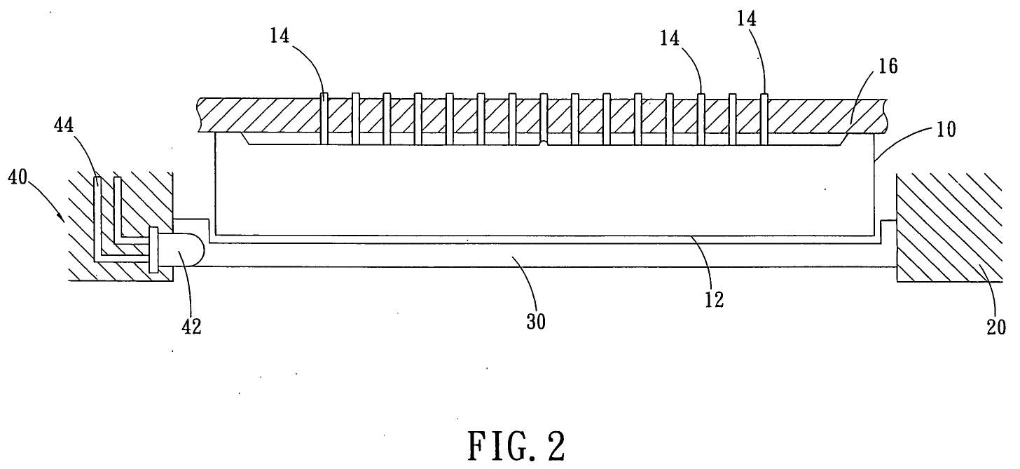

Referring to FIG. 2, wherein the light emitting diode display 10 is provided at a side with a display panel 12 for displaying characters or graphics, while on the other side opposite to the display panel 12 is defined with plural leads 14 which are employed to insert in a circuit board 16, so as to be connected to the circuit of the circuit board 16, and thus the display panel 12 is able to display characters or graphics.

A light guide plate 30 is fixed to shell of the house appliances 20 and corresponds to the display panel 12 of the light emitting diode display 10. It is noted that the light guide plate 30 can be made of light-transmittance material, and the light guide plate 30 can be fixed to the shell of the house appliances 20 by engaging or inserting method. Since the engaging or inserting method is not the main technical characteristics of the present invention, it is omitted here.

At least a light source 40 serves to project light into the light guide plate 30, and it includes luminous portion 42 and lead portion 44. Wherein the lead portion 44 can be electrically connected to the circuit board 16 or can be inserted directly in the circuit board 16. The luminous portion 42 is set at a side of the light guide plate 30 or inserted in the side of the light guide plate 30, such that the light can be projected into the light guide plate 30 when the light source 40 is lighting.

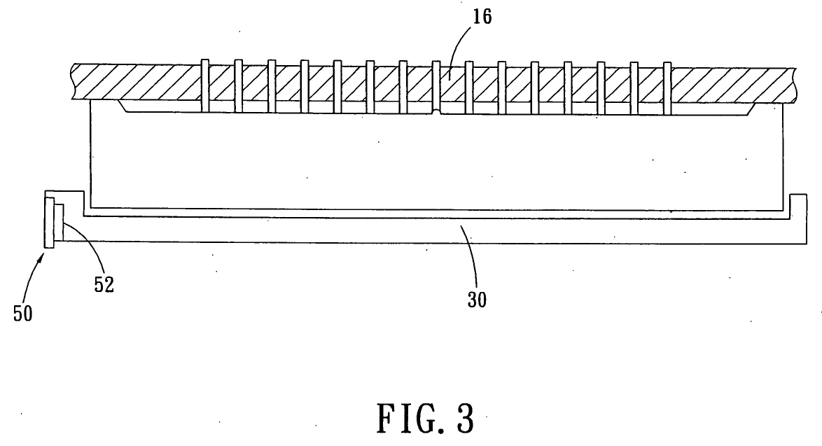

The above-mentioned light source 40 can be light emitting diode lamp, or SMD lamp 50 (as shown in FIG. 3). The SMD lamp 50 also should be electrically connected to the circuit board 16, and in like manner, it is set at or inserted in a side of the light guide plate 30. Whatever the light source 40 is light emitting diode lamp or SMD lamp, it can be plural in number, and different light source 40 can be provided with different color light.

In the above-mentioned embodiment, the light source 40 serves to project light into the light guide plate 30. When the light reflects in the light guide plate 30 and passes through it, the light guide plate 30 form colorful light screen. If the light guide plate 30 is provided with plural light sources 40 with different colors, wherein the plural light sources 40 project light by turns or at once, in this manner, with the variation in sequence of light or mixture of the light, the light guide plate 30 is provided with different displaying effects.

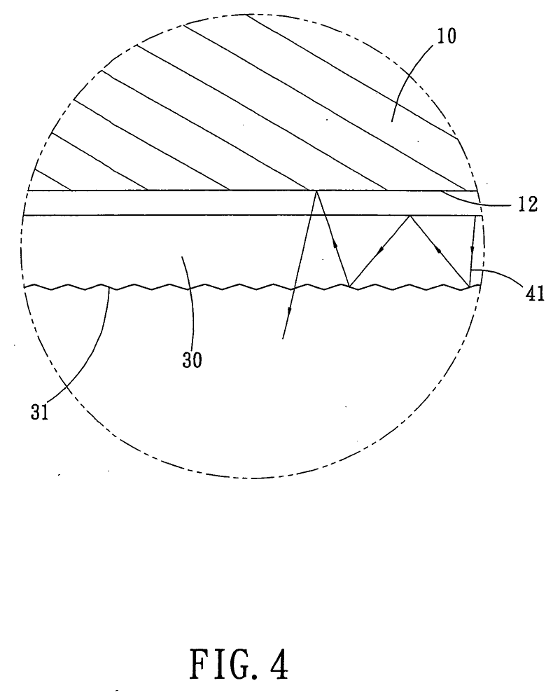

Referring to FIG. 4, after being reflected, the light 41 can pass through the light guide plate 30 and projects on the display panel 12 of the light emitting diode display 10. And then the light will turn into another color after it is reflected by the display panel 12 and passes through the light guide plate 30 since the color of the light is mixed with the color of the display panel 12. In order to more clearly disclose the travel path of the light, the above-mentioned drawings don't show the refraction phenomenon when the light passes through different medium substances. And it has no influence on the light screening effect of the light guide plate 30 when the light refraction phenomenon is neglected.

To make sure that the light 41 projected by the light source 40 can be truly reflected and focused, the surface of the light guide plate 30 is formed with transmission structures 31 by etching or chasing or other suitable means, so as to improve the transmission efficiency of the light source.

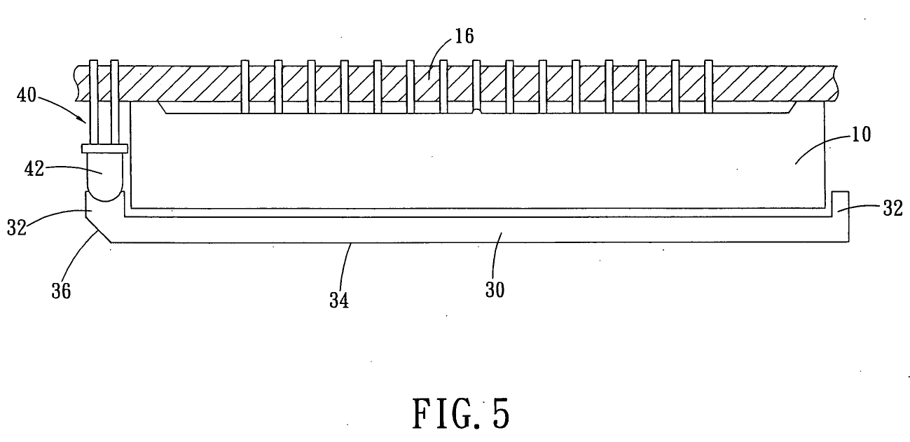

Besides being set at the side of the light guide plate 30, the light source 40 also can cooperate with the light guide plate 30 by other ways. With reference to FIG. 5, wherein the light source 40 is disposed on the circuit board 16, the light guide plate 30 is provided at both sides with extension 32, and the distal end of the extension 32 preferably extends toward the circuit board 16. In this way, the luminous portion 42 of the light source 40 corresponds to the extension 32 of the light guide plate 30, or it can be inserted in the extension 32. Since the extension 32 and a main visual screen 34 of the light guide plate 30 define an angle, a reflection plane 36 can be defined between the extension 32 and a main visual screen 34. In this way, the light of the light source 40 can be reflected into the man visual screen 34 after it projects on the reflection plane 36, and thus the light guide plate 30 can form a light screen. The reflection plane 36 can be shaped in the form of oblique plane or curved plane, and more preferably on the outer surface of the reflection plane 36 can be adhered with light-tight reflecting film or reflecting paper, so as to improve the light reflecting effect.

All the structures disclosed in the above-mentioned embodiments can enable the light guide plate 30 in front of the display panel 12 of the light emitting diode display 10 to form light screen. However, the real operation, it can be incorporated with a controlling device for controlling the brightness of the light source 40 and the light emitting diode display 10, so as to select desired hue for display. In other words, the light guide plate 30 in accordance with the present serves to provide different transmission colors, so as to provide dynamic changes in color.

It is to be noted that the light emitting diode display 10 is an actively emissive display which can generate light source by itself, thus it can provide a better lighting effect.

While we have shown and described various embodiments in accordance with the present invention, it should be clear to those skilled in the art that further embodiments may be made without departing from the scope of the present invention.

What is claimed is:

1. A light emitting diode display having a light guide plate, comprising:
the light emitting diode display provided at a side with a display screen for displaying characters or graphics, wherein the light emitting diode display is an actively emissive display which can generate light source by itself;
the light guide plate being light-transmission and disposed in the front of the light emitting diode display in corresponding to the display screen;
at least a light source, which has a luminous portion, after assembly, the luminous portion corresponds to the light guide plate and being able to project light into the light guide plate;
wherein the light of the light source can reflect in the light guide plate and can pass through the light guide plate, so as to form light screen for providing an effect of multi-layer optical display.

2. The light emitting diode display having the light guide plate as claimed in claim 1, wherein the light source is a light emitting diode type lamp.

3. The light emitting diode display having the light guide plate as claimed in claim 1, wherein the light source is a surface mounted type lamp.

4. The light emitting diode display having the light guide plate as claimed in claim 1, wherein the light emitting diode display is disposed on a circuit board, and the light source is electrically connected to the circuit board.

5. The light emitting diode display having the light guide plate as claimed in claim 1, wherein the light emitting diode display is disposed on a circuit board, and the light source is inserted in the circuit board.

6. The light emitting diode display having the light guide plate as claimed in claim 1, wherein the luminous portion of the light source corresponds to a side of the light guide plate, such that light can be projected into the light guide plate via the side.

7. The light emitting diode display having the light guide plate as claimed in claim 1, wherein a front surface of the light guide plate is defined as a main visual screen, whereas the main visual screen is provided at both sides with extension, and a reflection plane is defined between the main visual screen and the extension, such that the light of the light source can be projected via the extension into the light guide plate, and then projected on the main visual screen after being reflected by the reflection plane.
